(19) United States
(12) Patent Application Publication
(10) Pub. No.: US 2014/0331338 A1
(43) Pub. Date: Nov. 6, 2014

(54) DEVICE AND METHOD FOR PREVENTING CONFIDENTIAL DATA LEAKS

(71) Applicants: Susumu Serita, Tokyo (JP); Yasuhiro Fujii, Tokyo (JP)

(72) Inventors: Susumu Serita, Tokyo (JP); Yasuhiro Fujii, Tokyo (JP)

(73) Assignee: Hitachi, Ltd.

(21) Appl. No.: 14/365,503

(22) PCT Filed: Feb. 9, 2012
(86) PCT No.: PCT/JP2012/052996

§ 371 Date: Jun. 13, 2014

(51) Int. Cl. H04L 29/06

(52) U.S. Cl. CPC H04L 63/123; H04L 63/10
USPC 726/30

(57) ABSTRACT

The present invention makes it possible to verify definition information and data in a remote environment while properly protecting confidential data definition information using encryption and the like. The present invention comprises: a step for hiding in an individual manner definition information, such as a word or partial character string representing confidential information, using encryption, hashing, or the like; a step for extracting and hiding in an individual manner a word, partial character string or other such element from data to be controlled; a step for transmitting the hidden element to a server; and a step for verifying, in a hidden manner as-is, the hidden definition information and the hidden element, and deciding whether information matching the definition information is included in the data to be controlled.

### TECHNICAL FIELD

The present invention relates to a technique for preventing information leaks by detecting confidential data on a computer and a network and properly controlling the data with encryption or the stop of output to outside.

### BACKGROUND ART

Companies have a large amount of confidential data, such as customer information. Electronic data which can be easily copied and moved is likely to be leaked. To prevent information leaks, a method for limiting the handling of confidential data by setting an access right to each user has been widely penetrated.

On the contrary, products and techniques for preventing leaks to outside by deciding whether data is confidential data according to the contents thereof have become widespread in recent years. The products and techniques are typically called “Data Loss Prevention (DLP)”. In DLP, what is important is a method for deciding whether data (data to be controlled) on a computer and a network corresponds to confidential data. As the deciding method, a method for verifying a previously designated keyword and data to be decided has been widely used. In addition, a method for deciding whether data to be decided corresponds to confidential data based on the similarity between a previously designated file and the data to be decided has also been used.

The previously designated contents (hereinafter, called definition information) sometimes include, per se, confidential information (e.g., a customer's name, a credit number, or the like). It is necessary to handle definition information in a safe place, such as a company intranet, in order to prevent an outside attacker and an inside malicious administrator from obtaining the information. It is also necessary to handle definition information in an easily accessible place, such as the Internet, for referring to and updating the definition information from plural locations. Further, with the widespread of cloud computing, companies are managing data on a data center provided by the third party. Therefore, it is expected that the need to manage definition information on the data center will be increased in the future.

The following conventional techniques are known for properly detecting and controlling confidential data in a company while safely protecting definition information in a remote environment.

Patent Literature 1 is known as a conventional technique for verifying definition information and data to be controlled in a remote environment. Patent Literature 1 discloses a method for verifying a previously set keyword and data to be controlled by using both the local matching service in an end point and the remote matching service on a server.

Patent Literature 2 is known as a conventional technique for the safety of definition information used for verification. Patent Literature 2 discloses a method for verifying an index generated from previously designated source data and data to be controlled. To prevent an attacker from obtaining information, the index does not include the source data itself, but includes the source data which is encrypted or hashed.

### CITATION LIST

### Patent Literature

PTL 1: US Patent No. 2006/0253445
PTL 2: WIPO PCT/US2006/005317

### Non Patent Literature

NPL 1: Dawn Xiaodong Song, David Wagner, Arian Perrig. “Practical Techniques for Searches on Encrypted Data”. In Proceedings of the 2000 IEEE Symposium on Security and Privacy, pages 44-55 (2000).
NPL 2: D. Boneh, G. D. Crescenzo, and R. O. et al., “Public key encyrption with keyword search,” in Advances in Cryptology-EURO CRYPT 2004, ser. LNCS, C. Cachin and J. Camenisch, Eds., vol. 3027. Springer-Verlag, 2004, pp. 506-522.
NPL 3: B. Bloom: “Space/Time Tradeoffs in Hash Coding with Allowable Errors”, Communications of the ACM 13:7, pp. 422-426, 1970.

### SUMMARY OF INVENTION

### Technical Problem

In Patent Literature 1, the definition information can be managed in a unified manner on the server connected to the network, and the definition information and the data to be controlled transmitted from the end point can be verified on the server. However, Patent Literature 1 does not describe a mechanism for protecting the definition information by using encryption. Therefore, Patent Literature 1 cannot prevent a malicious database administrator from obtaining and abusing the definition information. In addition, Patent Literature 1 does not describe the protection of the data to be controlled which is transmitted to the server. Therefore, the information safety of the data to be controlled cannot be assured when the server is managed by a data center provided by a third party.

In Patent Literature 2, the index is encrypted or hashed, so that confidential information can be prevented from being leaked from the index. However, Patent Literature 2 does not disclose a specific method for verifying the encrypted or hashed index and the data to be controlled.

When an index is encrypted in its entirety to be stored and decoded before verification, it is in a memory in a raw state for a certain time. In addition, it is necessary to manage a key necessary for decoding. Therefore, a malicious DB administrator can obtain the key to decode the encrypted information.

To prevent the raw index from being exposed, a verifying method without decoding the encrypted definition information can be considered. However, only with the conventional encryption or hashing, the process result has a random value. Consequently, the index and data to be controlled cannot be verified.

The present invention has been made in consideration of the above problems, and an object of the present invention is to make it possible to perform verification in a remote environment while properly protecting definition information using encryption and the like.

### Solution to Problem

To achieve the above object, in the present invention, hidden definition information is managed on a server to decide on the server whether data to be controlled is confidential. The definition information is hidden when a DB administrator sets it. Therefore, the administrator cannot estimate the contents of the definition information. Whether the data to be controlled is confidential is decided by verifying a verifying query generated from the data to be controlled and the hidden definition information managed on the server.

The verifying query is generated by extracting an element (e.g., a word or partial character string) suitable for verifying the query and the definition information from the data to be controlled to hide the element by using encryption or hashing. The element is hidden to be comparable with a reference which hides the definition information set as confidential information. Plural methods which can compare two pieces of hidden information in a hidden manner as-is can be considered. As simple methods, there are encryption using the same key with the same shared key encryption algorithm and hashing with the same hash algorithm. A more complicated method called searchable encryption may be used. With the use of these methods, whether original information is the same can be decided in a hidden manner as-is. The details of these methods will be described in examples.

The data to be controlled itself is not hidden, but the word or partial character string extracted from data to be hidden is hidden in an individual manner. Therefore, verification is enabled at fine granularity, such as a word or partial character string.

The entire flow of a process for deciding confidential data on a server is as follows.

First, the server receives a confidentiality decision request for data to be controlled, verifies definition information and a query by the above method, and extracts an element which is included in the data to be controlled and matches the definition information. Next, the confidentiality degree of the data to be controlled is decided based on the result and previously designated confidential data classification rules (category rules). Finally, the server notifies the decision result to the device which transmits the confidentiality decision request. The device controls the data to be controlled according to the notification result.

During the above process, the definition information and the data to be controlled are hidden on the server. Therefore, confidential information cannot be obtained even when an incorrect administrator observes the data on the server.

### Advantageous Effects of Invention

According to the present invention, confidential data can be detected in a remote environment while protecting definition information to prevent information leaks.

### BRIEF DESCRIPTION OF DRAWINGS

FIG. 1 is a diagram showing the example of a system configuration.

FIG. 2 is a diagram showing the example of a computer.

FIG. 3 is a diagram showing the example of a policy management server.

FIG. 4 is a diagram showing the example of a device to be controlled.

FIG. 5 is a diagram showing the example of an administrator's terminal.

FIG. 6 is a table showing the example of control rules.

FIG. 7 is a table showing the example of a reference table.

FIG. 8 is a table showing the example of a log 315.

FIG. 9 is a table showing the example of a local filter.

FIG. 10 is a table showing the example of category rules.

FIG. 11 is a flowchart showing the example of the flow of the process of a control module.

FIG. 12 is a flowchart showing the example of the flow of the process of a policy inquiry module.

FIG. 13 is a flowchart showing the example of the flow of the process of a query generation module.

FIG. 14 is a flowchart showing the example of the flow of the process of a policy decision module.

FIG. 15 is a flowchart showing the example of the flow of the process of a security verification module.

FIG. 16 is a flowchart showing the example of the flow of the process of a reference security module.

FIG. 17 is a diagram showing the outline of processes.

### DESCRIPTION OF EMBODIMENTS

Hereinafter, an embodiment of the present invention will be described by referring to the drawings, if necessary.

(System Configuration)

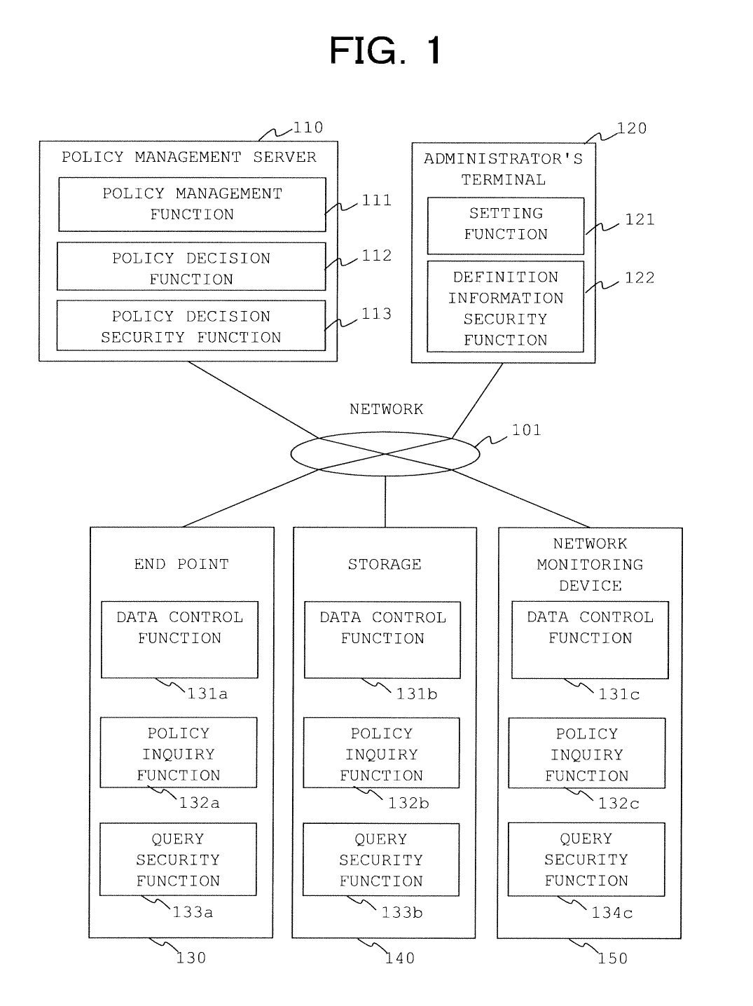

FIG. 1 is a diagram showing the example of a system configuration according to the embodiment of the present invention. As shown in FIG. 1, this system includes a policy management server 110, an administrator's terminal 120, and a device to be controlled. Further, the device to be controlled includes an end point 130, a storage 140, and a network monitoring device 150 such as a PC and mobile device, which are all devices that an employee in a company uses for daily tasks. These devices are connected to each other via a network 101.

The “policy” in this example is information on confidential information and a controlling method.

Each of the devices to be controlled 130 to 150 hides an element extracted from data to be controlled based on a confidentiality decision request, creates a verifying query, and transmits the query to the policy management server 110. The administrator's terminal 120 transmits, to the policy management server 110, a reference which hides definition information to be set as confidential information. The policy management server 110 verifies the hidden verifying query and the hidden reference, and decides the confidentiality degree of the verification result. Each of the devices to be controlled 130 to 150 controls the data to be controlled based on the confidentiality degree decision result, and registers the result, as a log, into the policy management server 110. Therefore, the policy management server 110 verifies, in a hidden manner as-is, the data to be controlled and the definition information (confidential information), and further decides the confidentiality degree.

The policy management server 110 has a policy management function 111, a policy decision function 112, and a policy decision security function 113.

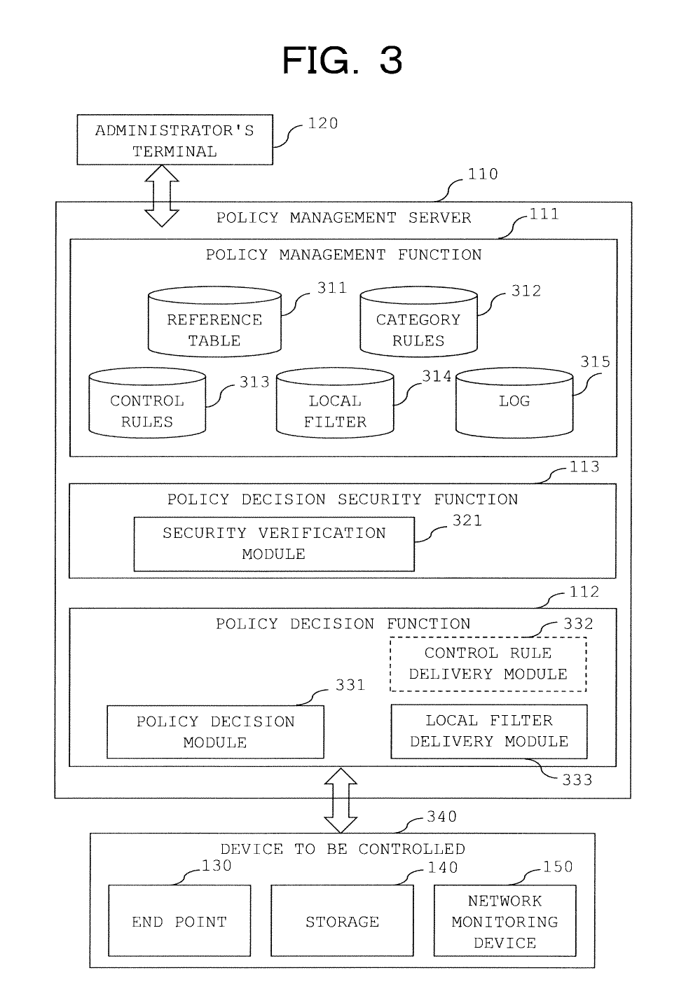

The policy management function 111 holds information necessary for confidential data decision and a confidential data controlling method, and changes and updates them, if necessary. The detail of the policy management function 111 will be described with reference to FIG. 3.

The policy decision function 112 decides whether certain data is confidential data, and decides a data controlling method. Hereinafter, the confidentiality degree decision for confidential data and the controlling method decision will be collectively called policy decision. The detail of the policy decision function 112 will be described with reference to FIG. 3.

The policy decision security function 113 performs the confidential data decision performed by the policy decision function 112 with a reference hiding the contents of definition information. The detail of the policy decision security function 113 will be described with reference to FIG. 3.

The administrator's terminal 120 has a setting function 121 and a definition information security function 122.

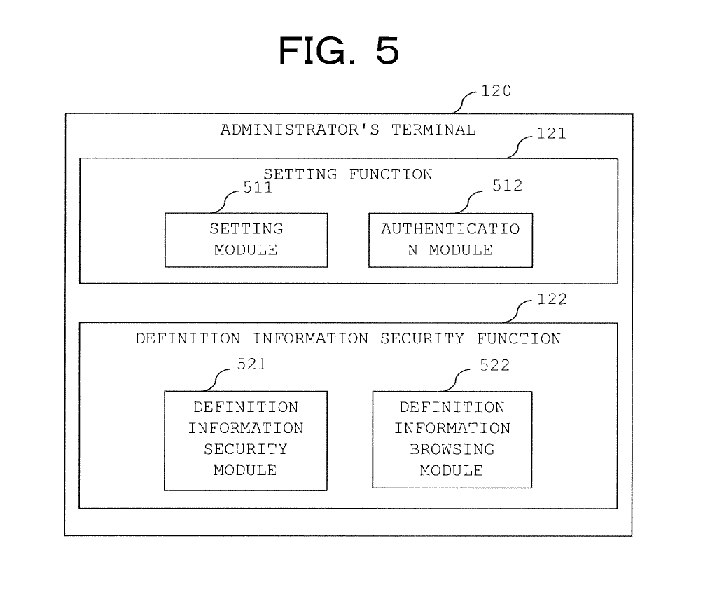

The setting function 121 allows an administrator with an access right to set, to the policy management server 110, information that the policy management server 110 uses for policy decision. The detail of the setting function 121 will be described with reference to FIG. 5.

The definition information security function 122 generates a reference which hides definition information registered into the policy management server 110. The detail of the definition information security function 122 will be described with reference to FIG. 5.

Each of the end point 130, the storage 140, and the network monitoring device 150 has a data control function 131, a policy inquiry function 132, and a query security function 133.

The end point 130 stores data, and copies or moves the data to another place, by e-mailing, printing through a printer, and outputting to an external recording medium.

The storage 140 is referred to as all devices, such as a file server or a document management server, which are used mainly for storing data. The storage 140 receives an access request from the user to output data.

The network monitoring device 150 monitors data flowing on a network, such as LAN (Local Area Network), to output log 315 information. The network device blocks obtained data, and changes a transmission designation. The network monitoring device 150 is a proxy server or a dedicated appliance.

As described above, the device to be controlled stores and outputs data. The data control function 131, the policy inquiry function 132, and the query security function 133 are linked to each other, and prevent confidential data stored in the device to be controlled from being outputted to the outside thereof. In this example, the three functions of the data control function 131, the policy inquiry function 132, and the query security function 133 included in the device to be controlled will be described in a unified manner regardless of the type of the device to be controlled (the end point 130, the storage 140, or the network). Each different process is specified according to the type of the device to be controlled.

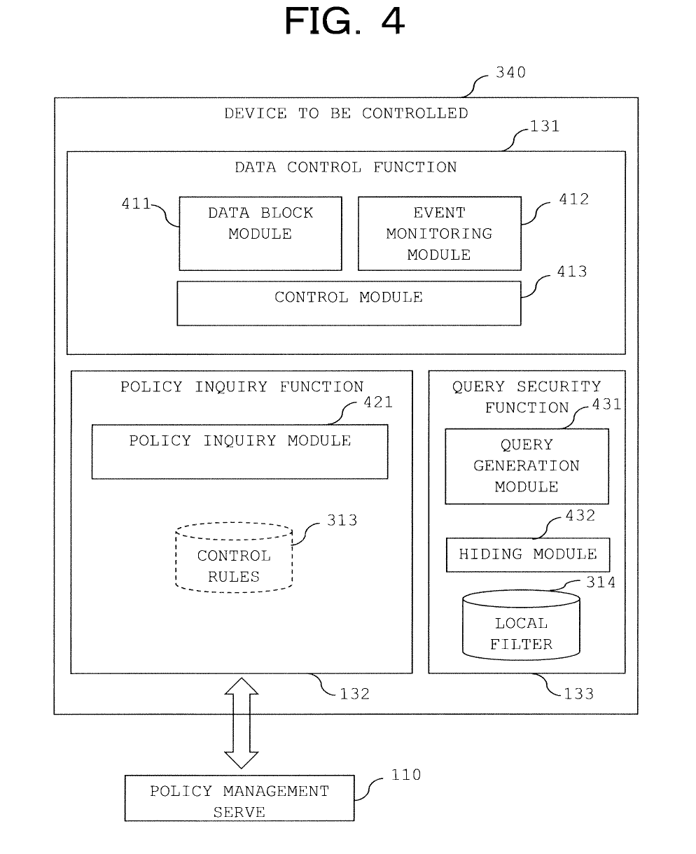

The data control function 131 obtains data to be outputted before the device to be controlled outputs the data, and stops the process according to the policy decision result of the data. The detail of the data control function 131 will be described with reference to FIG. 4.

The policy inquiry function 132 inquires, to the policy management server 110, the policy of data obtained by the data control function 131. The detail of the policy inquiry function 132 will be described with reference to FIG. 4.

The query security function 133 hides a query that the policy inquiry function 132 transmits for inquiring a policy. The detail of the query security function 133 will be described with reference to FIG. 4.

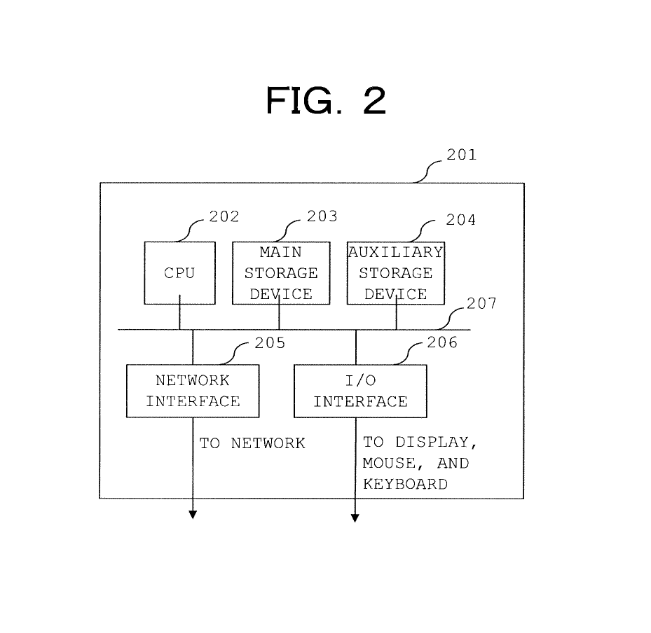

The example of a computer will be described with reference to FIG. 2. Each device connected to the network 101 is a computer having at least a CPU (Central Processing Unit), a storage device, and a communication device. As shown in FIG. 2, in a computer 201, hardware resources including a CPU 202, a main storage device 203 and an auxiliary storage device 204 (these are a storage device 210), a network interface 205 (communication device) connected to the network 101, an I (Input)/O (Output) interface 206 connected to display means (output device) such as a display and an input device such as a keyboard or mouse, and a conveyable medium connection portion which connects the computer 201 and a conveyable medium, such as a USB memory, are connected to each other via an internal bus 207.

Herein, the main storage device 203 and the auxiliary storage device 204 will be simply collectively called the “storage device 210”. In addition, of course, each computer connected to the network 101 has a hard disk drive (the auxiliary storage device 204) or a ROM (Read Only Memory), which stores a prog315ram necessary for the information process of this embodiment.

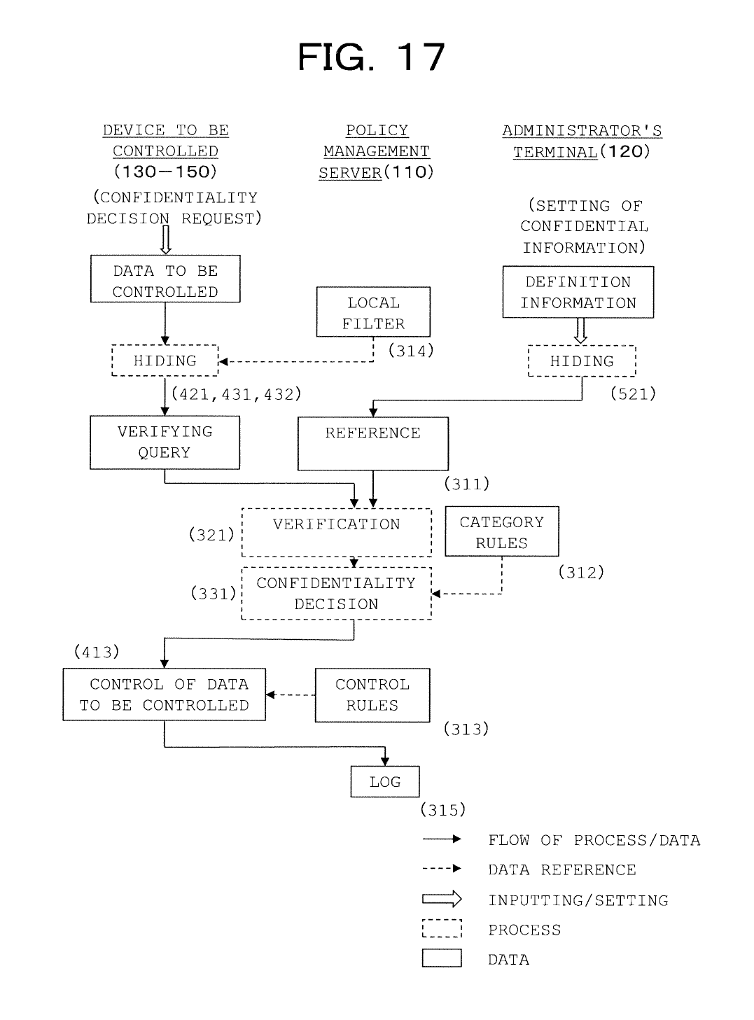

Here, the outline of processes in this example will be described with reference to FIG. 17. FIG. 17 shows the relation between data (solid line box) and each process (dashed line box) associated with each of the devices to be controlled 130 to 150, the policy management server 110, and the administrator's terminal 120. The number in parentheses given to each data piece or process is the reference numeral of each data piece, function, or module, which will be described later. Each solid line arrow indicates the flow of each process/data piece. Each dashed line arrow indicates data reference in each process.

The administrator's terminal 120 to which definition information to be set as confidential information is inputted hides the definition information to generate a reference (521), and transmits the reference to the policy management server 110.

Each of the devices to be controlled 130 to 150 receives a confidentiality decision request, refers to a local filter 314 held by the policy management server 110, extracts and hides (421, 431, 432) an element (a word or partial character string) from data to be controlled which is to be decided, generates a verifying query including the hidden element, and transmits the query to the policy management server 110.

The policy management server 110 verifies the hidden verifying query from each of the devices to be controlled 130 to 150 and a hidden reference 311 from the administrator's terminal 120 (321). The verification result is subjected to confidentiality decision 331 based on category rules 312 held by the policy management server 110. Then, the confidentiality decision result is transmitted to each of the devices to be controlled 130 to 150.

Each of the devices to be controlled 130 to 150 refers to control rules 313 held by the policy management server based on the confidentiality decision result from the policy management server 110. Each of the devices to be controlled 130 to 150 controls the data to be controlled by a controlling method according to a confidentiality degree obtained by the confidentiality decision (413). Each of the devices to be controlled 130 to 150 registers the control result as the log 315 into the policy management server 110.

As described above, in this example, the definition information which is set as confidential information by the administrator's terminal 120 and the data to be controlled which is inputted as the confidentiality decision request by each of the devices to be controlled 130 to 150 are hidden on the terminal side and the device side, respectively. Then, the policy management server 110 verifies and decides the hidden information. Therefore, confidential information setting and confidentiality decision can be requested to the policy management server 110 while plain text image information is hidden.

The example of each function included in the policy management server 110 will be described with reference to FIG. 3.

The policy management function 111 has a reference table 311, the category rules 312, the control rules 313, the log 315, and the local filter 314.

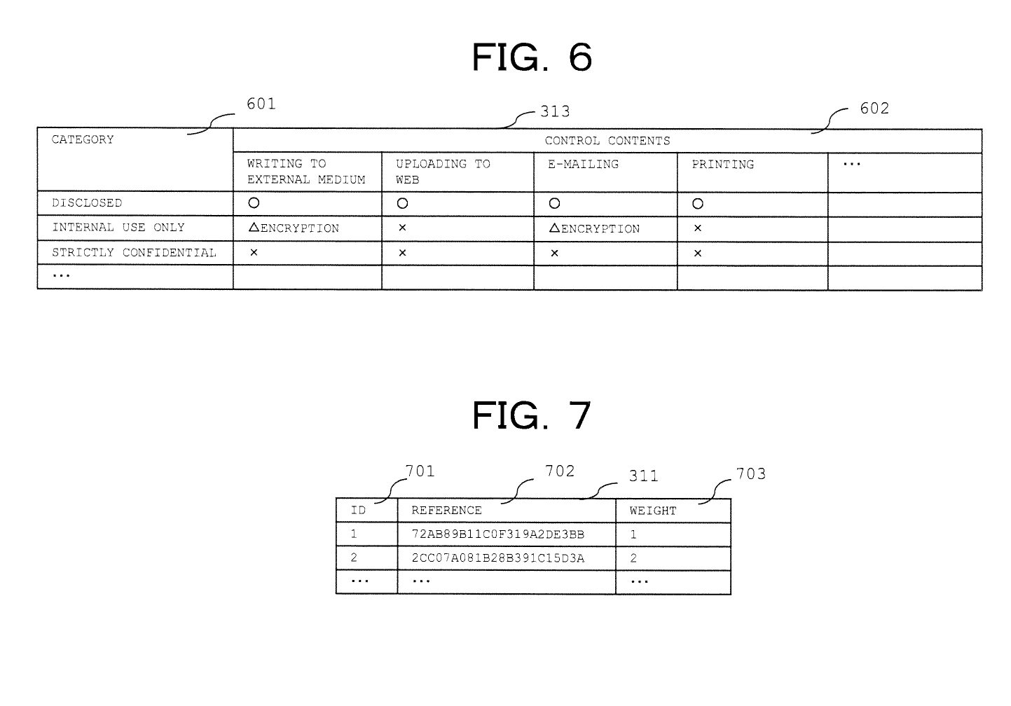

The reference table 311 manages a reference that the policy decision module 331 uses for deciding confidential data. For instance, a keyword representing confidential information is used as the reference. As described in the background art, the reference typically includes confidential information. Accordingly, the present invention decides confidential data while storing the reference so as to prevent confidential information from being obtained therefrom. The detail of the reference will be described with reference to FIG. 7.

The category rules 312 are information that the policy decision module 331 uses for deciding confidential data together with a reference. In a company, data is not divided into two types of confidential data and non-confidential data, but is typically divided into plural types according to confidentiality degree to change a controlling method for each type. In the present invention, each type according to confidentiality degree is called a “category”. For discrimination, each category has a name such as “disclosed”, “internal use only”, or “strictly confidential”. The category rules 312 define a method for deciding, from a reference, to which category certain data belongs. The detail of the category rules 312 will be described with reference to FIG. 10.

The control rules 313 allow the policy decision module 331 to decide a data controlling method. The control rules 313 define rules of what process is enabled with respect to data belonging to each category. The detail of the control rules 313 will be described with reference to FIG. 6.

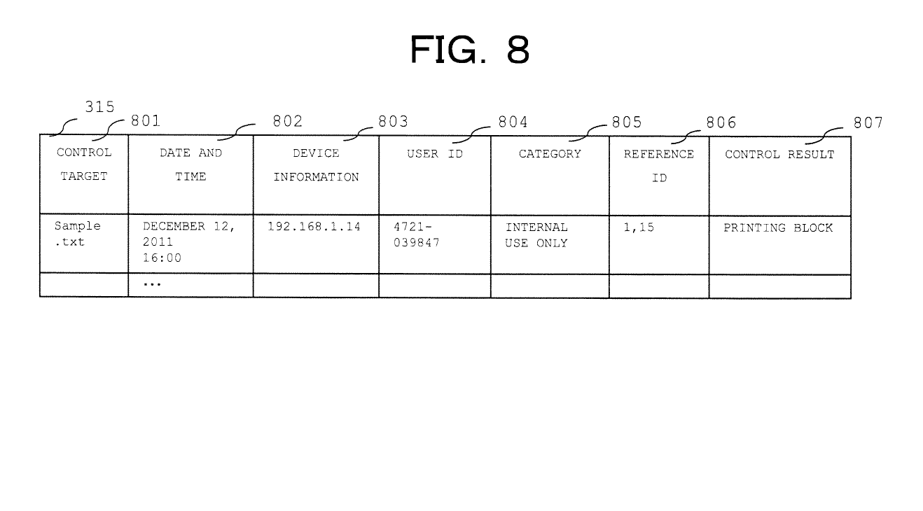

The log 315 is information which records the result in which the data control function 131 controls data in the device to be controlled. The detail of the log 315 will be described with reference to FIG. 8.

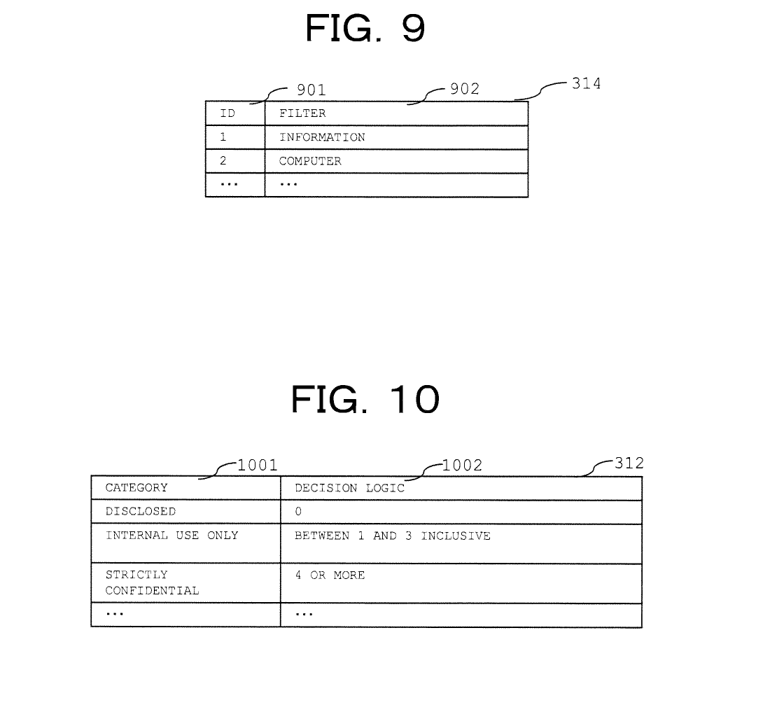

The local filter 314 defines unnecessary information when the policy decision module 331 decides the policy of data, and is used when the query generation module 431 generates a query for policy inquiry. That is, an element (a word or partial character string) selected from data to be controlled by the local filter 314 is hidden to generate a verifying query. The detail of the local filter 314 will be described with reference to FIG. 9.

The policy decision function 112 has the policy decision module 331, a local filter 314 delivery module, and a control rule delivery module 332.

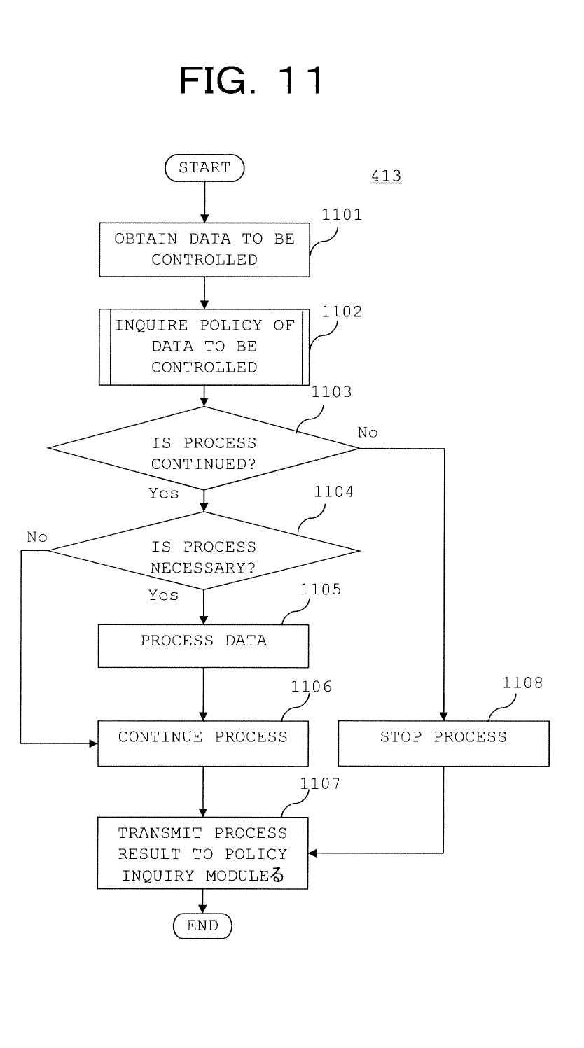

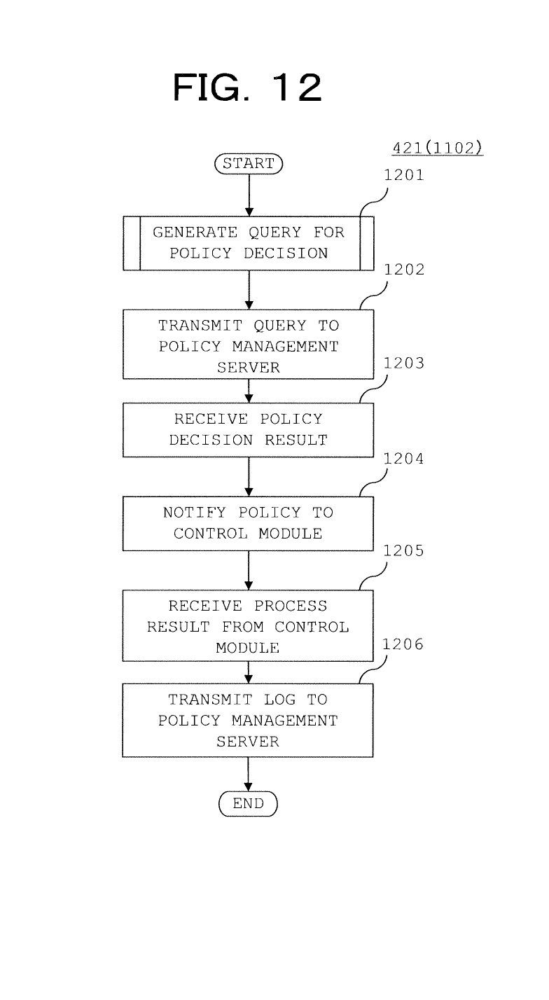

The policy decision module 331 decides the policy of data to be controlled from a query transmitted from the device to be controlled or verifies a verifying query and a reference, decides the confidentiality degree thereof based on the category rules 312, and transmits the decision result of the policy to the device to be controlled. The detail of the policy decision module 331 will be described with reference to FIG. 11.

The local filter delivery module 333 transmits, to the device to be controlled, the local filter 314 held by the policy management function 111. The local filter 314 delivery module holds therein the address information of the device to be controlled which is a transmission destination, refers to the address information, and transmits the local filter 314 to the controller. In each of the controllers 130 to 150, the policy inquiry function 132 selects an element to be hidden from data to be controlled by using the local filter 314. The local filter 314 is transmitted immediately after it is changed and immediately after a new device to be controlled is introduced. An administrator may issue a transmission request to the local filter 314 delivery module via the administrator's terminal. The local delivery module may detect the change of the local filter 314 and the addition of a new device to be controlled.

The control rule delivery module 332 transmits, to the device to be controlled, the control rules 313 held by the policy management function 111. Like the local filter 314, the control rules 313 refer to the address information of the device to be controlled therein for transmission to the controller. The control rule delivery module 332 of the control rules 313 is unnecessary when controlling method decision is performed on the policy management server 110. The policy decision module 331 refers to the control rules 313 in the policy management server 110 when the controlling method decision is performed on the server.

The policy decision security function 113 has the security verification module 321.

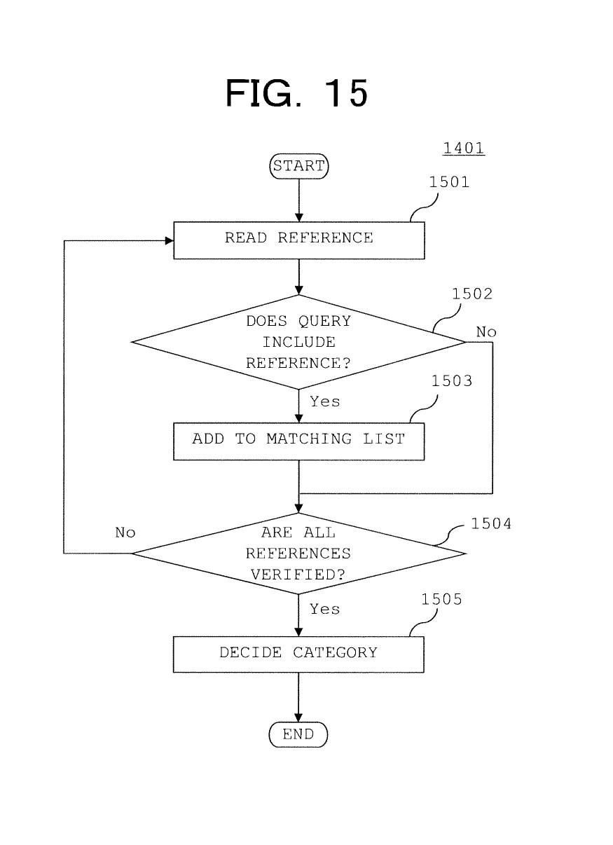

The security verification module 321 verifies a hidden reference stored in the reference table 311 and a query transmitted from the device to be controlled, and decides the category of data to be controlled. The detail of the process of the security verification module 321 will be described with reference to FIG. 15.

The example of each of the devices to be controlled 130 to 150 will be described with reference to FIG. 4.

The data control function 131 has a data block module 411, an event monitoring module 412, and a control module 413.

The data block module 411 blocks the output of data from a device to be controlled 340. The device to be controlled 340 typically has plural outputting methods. The data block module 411 may block all outputting methods or may block only a previously designated outputting method. For instance, to block printing, a printing port should be inhibited from being used. In addition, the data block module 411 which receives a block release instruction from the control module 413 releases the block. When only the log 315 is obtained without controlling data, the data block module 411 is unnecessary.

The event monitoring module 412 monitors event occurrence in the device to be controlled 340, and notifies data output event occurrence to the control module 413. This function can be realized using API provided by an OS.

The control module 413 obtains data to be outputted from the device to be controlled 340 (data to be controlled), inquires the policy of the data to be controlled to the policy management server 110 via the policy inquiry module 421, and controls the data to be controlled according to the result. The detail of the control module 413 will be described with reference to FIG. 11.

The policy inquiry function 132 has the policy inquiry module 421, and the control rules 313.

The policy inquiry module 421 inquires the policy of data to be controlled to the policy management server 110, and transmits the received result to the control module 413. The detail of the policy inquiry module 421 will be described with reference to FIG. 12.

The control rules 313 have the same contents as the control rules 313 described in FIG. 3. When controlling method decision is performed on the policy management server 110, the control rules 313 in the controller are unnecessary.

The query security function 133 has the query generation module 431, and a hiding module 432.

The query generation module 431 generates a query to allow the policy inquiry module 421 to inquire the policy of data to be controlled to the policy management server 110. The query is hidden to prevent the contents of the data to be controlled from being estimated therefrom.

The hiding module 432 performs encryption or hashing to allow the query generation module 431 to hide a query.

The local filter 314 is the same as the local filter 314 described with reference to FIG. 3. The local filter 314 is delivered to the controller by the local filter delivery module 333.

The example of the administrator's terminal 120 will be described with reference to FIG. 5.

The setting function 121 has a setting module 511, and an authentication module 512.

The authentication module 512 authenticates the user using the administrator's terminal 120. The authentication method uses a password and biological information. In addition, the authentication module 521 limits the function of the administrator's terminal 120 usable by the user based on user information held therein.

The setting module 511 provides an interface such as GUI or CUI to allow an administrator to perform various settings. In addition, the setting module 511 transmits, to the policy management server 110, a policy inputted by the administrator, and registers the policy into the policy management server 110. The setting module 511 transmits information as-is, which is inputted by the administrator and is not required to be hidden, such as the category rules 312, the local filter 314, and the control rules 313. However, the setting module 511 hides information which is inputted by the administrator and includes confidential contents such as definition information, by the definition information security function 122, and transmits it to the policy management server 110.

The definition information security function 122 has a definition information security module 521, and a definition information browsing module 522.

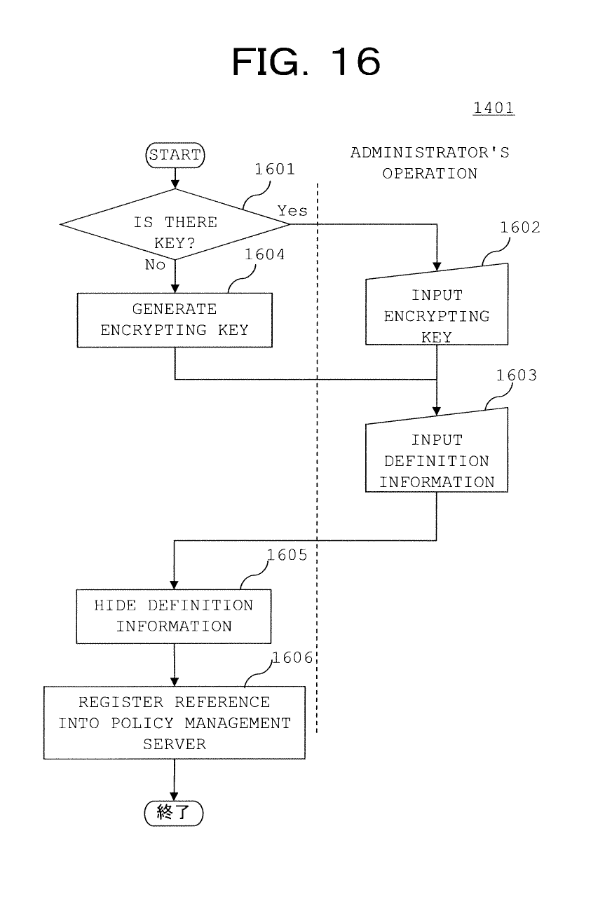

The definition information security module 521 can verify definition information inputted by an administrator and a hidden query transmitted from the controller, and can hide the contents of the definition information into an unestimable state. The detail of the definition information security module 521 will be described with reference to FIG. 16.

The definition information browsing module 522 restores an unhidden reference from a hidden reference managed by the policy management server 110 in order to confirm or correct inputted definition information, or restores the reference to the original definition information. The definition information browsing module 522 restores the reference to the original definition information by using a restoring key inputted by an administrator.

(Tables)

The example of the control rules 313 showing the correspondence between each confidential level and a process according to the level will be described with reference to FIG. 6.

The control rules 313 include a category 601, and control contents 602.

The category 601 includes names representing confidential levels to which data belongs. In the example of FIG. 6, the “disclosed”, “internal use only”, and “strictly confidential” categories are set.

The control contents 602 represent a process that the control module 413 performs to data to be controlled in the controller. The control contents 602 have plural output functions, and include limited contents with respect to each output function. The “◯” indicates non-limited contents, the “x” indicates limited contents, and the “Δ” indicates conditional limited contents. The limited contents include e.g., “x: output inhibition” and “Δ: encryption and output”. In the example of FIG. 6, for data belonging to the category “internal use only”, writing to an external medium and e-mailing are enabled by encryption, but uploading to the Web and printing are inhibited.

The example of the reference table 311 will be described with reference to FIG. 7. The reference table 311 includes an ID 701, a reference 702, and a weight 703.

The ID 701 is an identifier which uniquely identifies the reference 702. The reference 702 is information which hides definition information which is set as confidential information by an administrator. The security verification module 321 verifies a hidden query transmitted from the device to be controlled and the reference which hides the definition information, and decides the category to which data to be controlled belongs.

The weight 703 represents the confidentiality degree of the reference 702. The weight is used when the security verification module 321 decides the category of an element included in data to be controlled. Therefore, a flexible decision logic in which the data to be controlled which matches a reference with a large weight is classified into the category with higher confidentiality degree. As the numerical value of the weight 703 is larger, the confidentiality degree becomes higher.

The example of the log 315 will be described with reference to FIG. 8. The log 315 includes a control target 801, a date and time 802, device information 803, a user ID 804, a category 805, a reference ID 806, and a control result 807.

The control target 801 represents information which identifies data to be controlled. For instance, a file name can be used. The date and time 802 represents time at which the device to be controlled performs control. The device information 803 represents information which identifies the device to be controlled which performs control. For instance, a device name and an IP address can be used. The user ID 804 represents information which identifies the user who outputs data to be controlled. For instance, an employee ID can be used.

The category 805 represents a category to which data to be controlled belongs. A category decided by the policy decision module 331 is reflected to this value. The reference ID 806 represents the ID of a reference included in data to be controlled or the ID 701. The result in which the security verification module 321 verifies the query of data to be controlled and the reference table 311 or the ID 701 of the reference 702 matching the query, is reflected to this value. The control result 807 represents the contents of control that the control module 413 performs to data to be controlled.

After the control module 413 performs control, the policy inquiry module 421 generates the log 315 to transmit it to the policy management server 110. Since data on the policy management server 110 can be browsed by a malicious server administrator, the policy inquiry module 421 can encrypt information in the log 315 which is not to be disclosed before transmitting the information. For that, the entire entry of the log 315 may be encrypted or only a control target may be encrypted.

The example of the local filter 314 which selects an element to be hidden from data to be controlled will be described with reference to FIG. 9. The local filter 314 includes an ID 901, and a filter 902.

The ID 901 represents information which identifies a filter.

The filter 902 represents information which identifies a portion which is not associated with policy decision in data to be controlled (a word or partial character string). For instance, the filter 902 includes a self-evident keyword. The filter 902 stores data which is not required to be hidden and verified. As a result, confidential information is hidden from the policy management server 110 which holds the local filter 314. The confidential information can thus be prevented from being leaked from the local filter 314.

The example of the category rules 312 will be described with reference to FIG. 10. The category rules 312 include a category 1001 and a decision logic 1002.

The category 1001 is the same as information defined by the control rules 313. The decision logic 1002 represents criteria to allow the policy decision module 331 to decide the confidentiality degree of the category with respect to the verification result of a hidden verifying query and a reference as hidden definition information. For instance, the decision logic 1002 includes the upper and lower limits of the total value of the weights of a matched reference.

(Process Procedures)

The example of the process of the control module 413 of each of the devices to be controlled 130 to 150 will be described with reference to FIG. 11.

The control module 413 starts the process when receiving data output event occurrence notification from the event monitoring module 412. That is, the event occurrence notification becomes a confidentiality decision request for data to be controlled.

In step 1101, the control module 413 obtains data to be controlled held by the device to be controlled. Information on the data to be controlled such as a file name is also obtained together. After obtaining, the routine goes to step 1102.

In step 1102, the control module 413 uses the information obtained in step 1101 to inquire the policy of the data to be controlled to the policy management server 110. That is, the control module 413 inquires whether an element (a word or partial character string) included in the data to be controlled is confidential information and a controlling method for the element. The inquiring process is performed via the policy inquiry module 421. The detail of the inquiring process will be described with reference to FIG. 12. After the inquiry result is obtained, the routine goes to step 1103.

In step 1103, the control module 413 decides whether the outputting process is continued or stopped based on the policy obtained in step 1102. When the process is continued, the routine goes to step 1104. When the process is stopped, the routine goes to step 1108.

In step 1104, based on the policy obtained in step 1102, the control module 413 decides whether the data to be controlled is required to be processed. When the data to be controlled is required to be processed, the routine goes to step 1105. When the data to be controlled is not required to be processed, the routine goes to step 1106.

In step 1105, the control module 413 processes the data to be controlled based on the policy obtained in step 1102. When the data to be controlled is encrypted, the control module 413 allows the user to set a password for decoding. After the data is processed, the routine goes to step 1106.

In step 1106, the control module 413 continues the outputting process of the data to be controlled. This process is realized in such a manner that the control module 413 instructs the data block module 411 to release the data block function. With this, the data to be controlled is outputted via the output function included in the device to be controlled. The data processed in step 1105 is outputted. After the processed data is outputted, the routine goes to step 1107.

In step 1108, the control module 413 stops the outputting process of the data to be controlled. Here, the control module 413 may perform an auxiliary process of displaying a pop-up screen to notify the stop of the process to the user. After the outputting process is stopped, the routine goes to step 1107.

In step 1107, the control module 413 transmits the process result of the data to be controlled to the policy inquiry module 421. When the outputting process is continued in step 1106, the process result includes information of whether the outputting process is ended without any problems or of whether a certain error is caused to stop the outputting process. Further, the control module 413 transmits the process result to the policy management server 110, and registers it into the log 315. When the control module 413 stops the outputting process in step 1106, the process result includes information of whether the outputting process is properly stopped. After transmitting the process result, the control module 413 ends the process.

The example of the process of the policy inquiry module 421 of each of the devices to be controlled 130 to 150 will be described with reference to FIG. 12.

The policy inquiry module 421 starts the process upon receiving the policy inquiry instruction of data to be controlled from the control module 413.

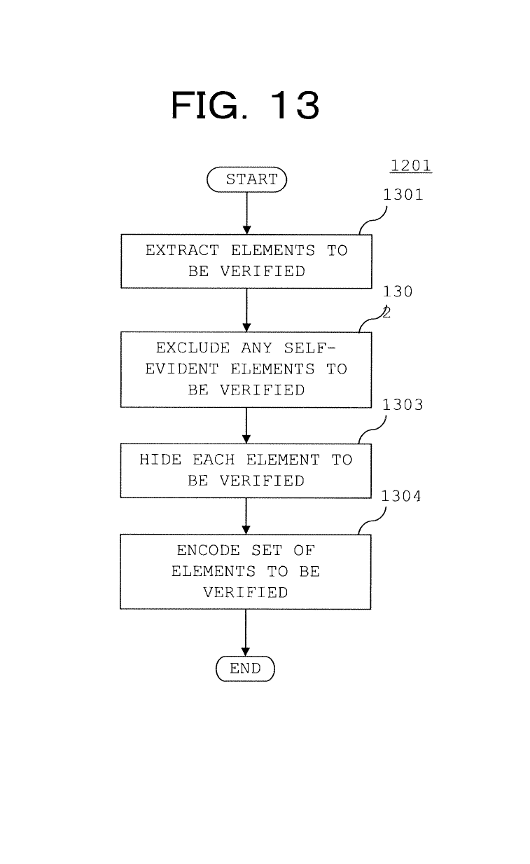

In step 1201, the policy inquiry module 421 generates, from data to be controlled, a query which inquires a policy to the policy management server 110. The query generation process is performed by using the query generation module 431. The detail of the query generation process will be described with reference to FIG. 13. After the policy inquiry module 421 generates the query, the routine goes to step 1202.

In step 1202, the policy inquiry module 421 transmits the query generated in step 1201 to the policy management server 110. Together with the query, the policy inquiry module 421 transmits additional information necessary for the confidentiality decision of the data to be controlled. The additional information includes information which identifies the device to be controlled (e.g., a machine name or an IP address) and the contents of an outputting process (e.g., printing and writing to a USB). After the query is transmitted, the routine goes to step 1203.

In step 1203, the policy inquiry module 421 receives the policy decision result from the policy management server 110. After reception, the routine goes to step 1204.

In step 1204, the policy inquiry module 421 notifies the policy decision result received in step 1203 to the control module 413. The control module 413 continues or stops the outputting process according to the received policy decision result. After notification, the routine goes to step 1205.

In step 1205, the policy inquiry module 421 receives the process result of the data to be controlled from the control module 413. After reception, the routine goes to step 1206.

In step 1206, the policy inquiry module 421 creates the log 315 of the processes for the data to be controlled, and transmits the log 315 to the policy management server 110. The contents of the log 315 include the contents shown in FIG. 8. After transmitting the log 315, the policy inquiry module 421 ends the process.

The example of the process (step 1201 in FIG. 12) of the query generation module 431 of each of the devices to be controlled 130 to 150 will be described with reference to FIG. 13. The query generation module 431 starts the process upon receiving a query generation instruction from the policy inquiry module 421.

In step 1301, the query generation module 431 analyzes data to be controlled to extract an element to be verified. The element to be verified represents data obtained by dissolving the data to be controlled into a unit such as a word or sentence which verifies it and a reference. A word can be the element to be verified by using a morphological analysis technique. A sentence can be the element to be verified by dissolving the data to be controlled with a particular code such as a punctuation mark or a new line character.

A set of adjacently appearing n words (word n-grams) or a set of adjacently appearing n characters (character n-grams) may be used as the element to be verified. After elements to be verified are extracted, the routine goes to step 1302.

In step 1302, the query generation module 431 excludes elements not contributing to policy decision from among the elements to be verified extracted in step 1301. This process is performed by referring to the local filter 314 to exclude any elements to be verified matching the conditions included in the local filter 314. After exclusion, the routine goes to step 1303.

In step 1303, the query generation module 431 hides the remaining elements to be verified which are not excluded in step 1302.

The hiding method used in the present invention will be described here. In the present invention, hiding which satisfies the following two characters is used.

(1) It is difficult for a person without an access right to restore hidden data into an unhidden state.

(2) Two hidden data pieces are compared so that whether they have the same unhidden data can be decided.

Some methods which satisfy the above characteristics can be considered. Representative methods will be described below, but the present invention is not limited to those methods.

As the simplest method, a hash function such as MD5 or SHA-1 is used. An administrator does not register a keyword or character string as-is as a reference, and registers a value obtained by applying the hash function thereto. The query generation module 431 generates a query from a set of values obtained by applying the hash function to elements extracted from data to be controlled. From the characteristic of the hash function, with the same original data, a value obtained by applying the hash function is the same. The security verification module 321 can thus verify the reference and the query. However, when the hash value is used, even the administrator cannot restore unhidden information from the reference.

As another method, encryption is used. Encryption is divided into shared key encryption such as DES or AES, and public key encryption such as RSA.

When the shared key encryption is used, an administrator hides a reference by a shared key which is known only by him/her, and registers the reference into the policy management server 110. Further, the administrator stores an encrypting key into the query generation module 431 in the device to be controlled. The query generation module 431 uses the stored encrypting key to encrypt each element extracted from data to be controlled. Unlike the case of using the hash value, the administrator decodes the reference registered into the policy management server 110 by using the shared key. The administrator can thus browse information on the unhidden reference.

When the public key encryption is used, the administrator hides a reference by, of a pair of a public key and a secret key, the public key, and registers the reference into the policy management server 110. Further, the administrator stores the public key into the query generation module 431 in the device to be controlled. The query generation module 431 uses the stored public key to encrypt each element extracted from data to be controlled. The administrator decodes the reference registered into the policy management server 110 by using the secret key. The administrator can thus browse information on the unhidden reference.

In the encryption, as long as a certain key is used, the same plain text always represents the same encrypted sentence. On the contrary, known is a technique in which even with a certain key, the same plain text represents a different encrypted sentence each time it is encrypted and in which the identity of the original plain text can be decided from the encrypted sentence. This technique is typically called “searchable encryption”. The searchable encryption may be used for hiding in the present invention. For the detail of the searchable encryption, see Non-Patent Literatures 1 and 2.

After the query generation module 431 hides each element, the routine goes to step 1304. In step 1304, the query generation module 431 encodes each element to be verified which is hidden in step 1303 into the form of being transmitted to the policy management server 110.

Encoding may be optional as long as the policy management server 110 can verify each element and a reference. For instance, for encoding in XML form, each element to be verified which is hidden in step 1303 should be represented by a hexadecimal digit character string and be substitute into a tag element. In addition, as another encoding, each element to be verified is stored into a Bloom filter. The Bloom filter has a stochastic data structure with good space efficiency, and is used for a test of whether a certain element is the member of a certain set. The Bloom filter has testing time of constant order without depending on the number of sets, and can have very small data size. On the contrary, the Bloom filter can erroneously decide that an element which is not included in the set belongs to the set. However, the possibility of erroneous decision can be optionally small by adjusting the number of sets and data size. For the detail of the Bloom filter, see Non-Patent Literature 3.

By storing each element to be verified into the Bloom filter, the policy management server 110 can shorten time to verify each element and a reference. In addition, the data size of a query transmitted to the policy management server 110 can be reduced. From the characteristic of the Bloom filter, there is a possibility that data which does not actually match a reference can be erroneously decided to match the reference. To cope with such a case, for a query that the policy management server 110 decides that it includes an element to be verified which matches a reference, an element to be verified in a complete form is requested again to the policy inquiry module 421. When most data to be controlled is non-confidential data, on the whole, the demerit of re-transmission can be compensated for by the merit of data reduction by the Bloom filter. After encoding all elements to be verified, the query generation module 431 ends the process.

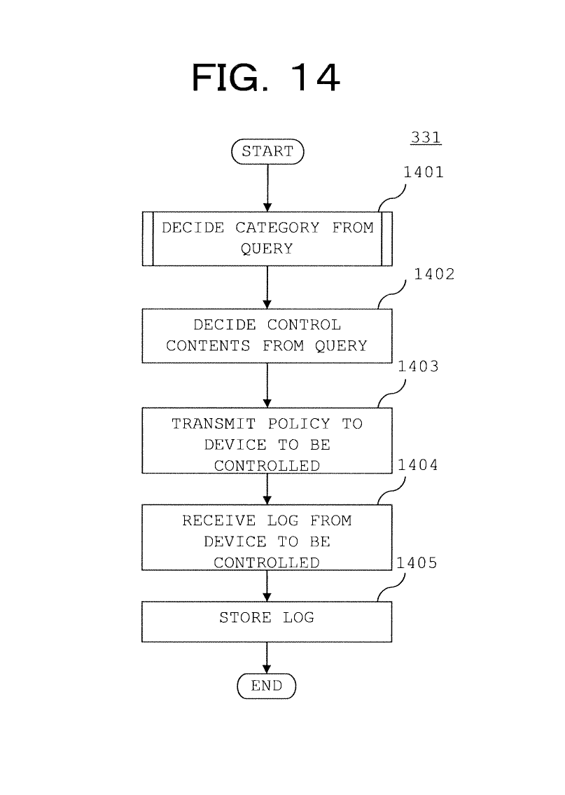

The example of the process of the policy decision module 331 of the policy management server 110 will be described with reference to FIG. 14. The policy decision module 331 starts the process upon receiving a query for policy decision of data to be controlled from each of the devices to be controlled 130 to 150.

In step 1401, the policy decision module 331 decides the category of data to be controlled from a query. This process is performed via the security verification module 321. For the detail of the process will be described with reference to FIG. 15. After the category of the data to be controlled is decided, the routine goes to step 1402.

In step 1402, the policy decision module 331 refers to the control rules 313, and decides the control contents 602 corresponding to the category 601 decided in step 1401. The policy decision module 331 should decide only the item of the control contents 602 matching the output contents received from the device to be controlled. For instance, when the query transmitted from the device to be controlled is “internal use only” and the output contents are “e-mailing”, “Δ: encryption” is decided. After the control contents are decided, the routine goes to step 1403.

In step 1403, the policy decision module 331 transmits the category decided in step 1401 and the control contents decided in step 1402 to the device to be controlled. After transmission, the routine goes to step 1404.

In step 1404, the policy decision module 331 receives, from each of the devices to be controlled 130 to 150, the log 315 which is the control result of the data to be controlled. After the policy decision module 331 receives the log, the routine goes to step 1405.

In step 1405, the policy decision module 331 stores the log 315 received in step 1404 into the log 315 managed in the policy management server 110. The policy decision module 331 adds information such as a reference ID recorded by the security verification module 321 to the log 315. After storing the log 315, the policy decision module 331 ends the process.

The example of the process (step 1401 in FIG. 14) of the security verification module 321 of the policy management server 110 will be described with reference to FIG. 15. The security verification module 321 starts the process when receiving the category decision instruction of a query from the policy decision module 331.

In step 1501, the security verification module 321 reads a reference from the reference table 311. After reading, the routine goes to step 1502.

In step 1502, the security verification module 321 verifies the reference read in step 1501 and a query. After verification, when the query includes the reference, the routine goes to step 1503. When the query does not include the reference, the routine goes to step 1504.

In step 1503, the security verification module 321 adds the reference verified in step 1502 to a matching list. The matching list shows data stored in the recording area in the security verification module 321, and includes the reference ID 701 and the weight 703. The recorded reference ID 703 is used as the reference ID 806 of the log 315. The weight is used for deciding the category in step 1505. After the reference is added to the matching list, the routine goes to step 1504.

In step 1504, the security verification module 321 decides whether all references included in the reference table 311 are verified. After decision, when all references are verified, the routine goes to step 1505. When all references are not verified, the routine returns to step 1501.

In step 1505, the security verification module 321 uses the matching list and the category rules 312 to decide the category of data to be controlled. When the decision logic 1102 is the example of FIG. 10, the weights of each reference included in the matching list are totaled for each reference. The corresponding category is then decided with respect to each reference according to the total value thereof. For instance, when the total value of the weights of the reference which is hidden information corresponding to definition information “credit number” included in the data to be controlled is “3”, the category 1001 is decided as “internal use only” from the decision logic 1002 of the category table 312 in FIG. 10. That is, the confidentiality degree of the definition information “credit number” is decided. After deciding the category, the security verification module 321 ends the process.

The example of the process of the definition information security module 521 of the administrator's terminal 120 will be described with reference to FIG. 16. The definition information security module 521 starts the process upon receiving a definition information hiding instruction from the setting module 511. That is, the process is started when definition information to be confidential information with respect to data to be controlled is inputted to the administrator's terminal 120.

In step 1601, the definition information security module 521 decides whether a key that an administrator uses for hiding is prepared. The setting module 511 allows the administrator to select whether the existing key is used or a new key is generated. The definition information security module 521 decides whether the key used for hiding is prepared based on the result selected by the administrator on the input interface of the setting module 511. After decision, when the key is prepared, the routine goes to step 1602. When the key is not prepared, the routine goes to step 1604. Like simple hashing, when hiding which does not require the key is used, the routine goes to step 1605.

In step 1602, the administrator inputs the key via the input interface provided by the setting module 511. The definition information security module 521 stores the inputted key into the storage area therein. After the administrator inputs the key, the routine goes to step 1603.

In step 1604, the definition information security module 521 generates a key used for hiding. The definition information security module 521 generates a key necessary for browsing at the same time. According to an encryption algorithm used, the same key as the case of using different keys for hiding and browsing can be used. After the key is generated, the routine goes to step 1603.

In step 1603, the administrator inputs definition information via the input interface of the setting module 511. The definition information security module 521 stores the inputted definition information into the storage area therein. After the administrator inputs the definition information, the routine goes to step 1605.

In step 1605, the definition information security module 521 hides the definition information to generate a reference. After hiding, the routine goes to step 1606.

In step 1606, the definition information security module 521 registers the reference into the reference table 311 of the policy management server 110. After registration, the definition information security module 521 ends the process.

### REFERENCE SIGNS LIST

101: network, 110: policy management server, 111: policy management function, 112: policy decision function, 113: policy decision security function, 120: administrator's terminal, 121: setting function, 122: definition information security function, 130: end point, 131: data control function, 132: policy inquiry function, 133: query security function, 140: storage, 150: network management device, 201: computer, 202: CPU, 203: main storage device, 204: auxiliary storage device, 205: network interface, 206: I/O interface, 207: internal bus, 311: reference table, 312: category rules, 313: control rules, 314: local filter, 315: log, 321: security verification module, 331: policy decision module, 332: control rule delivery module, 333: local filter delivery module, 411: data block module, 412: event monitoring module, 413: control module, 421: policy inquiry module, 431: query generation module, 432: hiding module, 511: setting module, 512: authentication module, 521: definition information security module, 522: definition information browsing module

1. A method for preventing confidential data leaks which monitors data on a computer and a network, decides the confidentiality of the data based on previously set definition information, and changes the process of the data according to the confidentiality, the method comprising:
a step for hiding the definition information and storing the hidden definition information onto the computer connected to the network; and
a step for verifying the data and the hidden definition information while the hidden definition information is in a hidden manner as-is and deciding the confidentiality.

2. The method according to claim 1, wherein a set of partial data structuring the data is extracted from the data, a data set generated by hiding respective elements of the set of the partial data is transmitted onto the computer holding the hidden definition information, the matching degree between the data set and the hidden definition information is measured, and the data and the hidden definition information are verified.

3. A system for preventing confidential data leaks in which an administrator's terminal setting confidential information, at least one device to be controlled controlling data to be controlled which is to be subjected to confidentiality decision, and a policy management server deciding the confidentiality degree of the data to be controlled based on the confidential information are connected to each other via a network,
wherein the administrator's terminal has definition information security means for receiving definition information to be set as the confidential information, generating a reference which hides the definition information, and transmitting the reference to the policy management server,
wherein the device to be controlled has:
hiding means for receiving a confidentiality decision request to hide an element extracted from the data to be controlled;
query generation means for generating a verifying query including the hidden element to transmit the query to the policy management server; and
control means for controlling the data to be controlled and registering, into the policy management server, a result of the control as a log, and
wherein the policy management server has:
verification means for verifying the verifying query and the reference; and
confidentiality decision means for deciding the confidentiality degree of a result of the verification and transmitting a result of the decision to the device to be controlled.

4. The system according to claim 3, wherein the hiding means of the device to be controlled is held by the policy management server and extracts the element based on a local filter identifying data which is not required to be hidden and verified.

5. The system according to claim 3, wherein the confidentiality decision means of the policy management server is held by the policy management server and decides the confidentiality degree of a result of the verification based on category rules which define criteria which decide the confidentiality degree of a category.

6. The system according to claim 3, wherein the control means of the device to be controlled is held by the policy management server and controls the data to be controlled based on control rules which define a controlling method according to the confidentiality degree obtained by the confidentiality decision.

7. A policy management server which is connected to an administrator's terminal and at least one device to be controlled via a network, the server comprising:
verification means for verifying a reference which is inputted from the administrator's terminal and hides definition information which is to be set as confidential information and a verifying query which is inputted from the device to be controlled and hides and generates an element extracted from data to be controlled; and
confidentiality decision means for deciding the confidentiality degree of a result of the verification and transmitting a result of the decision to the device to be controlled.

8.-13. (canceled)
